(19) United States
(12) Patent Application Publication
(10) Pub. No.: US 2025/0384510 A1
(43) Pub. Date: Dec. 18, 2025

(54) CREATING AND UPDATING A DATA VARIABLE IN A COMPUTER-AIDED DISPATCH SYSTEM

(71) Applicant: MOTOROLA SOLUTIONS, INC., CHICAGO, IL (US)

(72) Inventors: CHEE YEW CHEONG, SUANG JAYA (MY); SEOH LI CHUA, TAIPING (MY); BING QIN LIM, BAYAN LEPAS (MY); BRIAN J. FROMMELT, NAPERVILLE, IL (US); YEW TATT SIM, BUTTERWORTH (MY); CHEN HANG CHIA, ALOR SETAR (MY)

(21) Appl. No.: 18/743,188

(22) Filed: Jun. 14, 2024

(51) Int. Cl. G06Q 50/26; G06F 3/0481; G06F 40/174

(52) U.S. Cl. CPC G06Q 50/265; G06F 3/0481; G06F 40/174

(57) ABSTRACT

In order to provide an accurate emergency dispatch to the scene of an evolving emergency incident, a computer-aided dispatch (CAD) system is configured to create a data variable for a particular data input characterizing an aspect of the incident. Using data analytics, the CAD system automatically analyzes ingested data associated with the incident, updates the value of the data variable, and uses the updated value as a basis for generating or updating dispatch commands.

### BACKGROUND

Call-takers at public safety answering points (PSAPs), or 9-1-1 emergency call centers (sometimes designated in other countries as 1-1-2, 9-9-9, and the like) collect contextual information from callers regarding emergency incidents, such as location, type of incident, and other details that can assist first responders in responding quickly to incidents. Based on the collected information, a call-taker can dispatch various emergency response resources to the scene of the incident, such as by way of a computer-aided dispatch (CAD) system.

### BRIEF DESCRIPTION OF THE DRAWINGS

FIG. 1 illustrates a public safety communications system, according to some examples.

FIG. 2 illustrates a PSAP analytics system, according to some examples.

FIG. 3 illustrates an emergency incident form, according to some examples.

FIG. 4 illustrates a user interface for creating and updating a data variable in a CAD system, according to some examples.

FIG. 5 illustrates a user interface for creating and updating a data variable in a CAD system, according to some examples.

FIG. 6 illustrates a user interface for creating and updating a data variable in a CAD system, according to some examples.

FIG. 7 illustrates a method for creating and updating a data variable in a CAD system, according to some examples.

FIG. 8 illustrates a schematic diagram of a computing device for performing the operations described herein, according to some examples.

Skilled artisans will appreciate that elements in the figures are illustrated for simplicity and clarity and have not necessarily been drawn to scale. For example, the dimensions of some of the elements in the figures may be exaggerated relative to other elements to help improve understanding of examples of the present disclosure.

The system, apparatus, and method components have been represented where appropriate by conventional symbols in the drawings, showing only those specific details that are pertinent to understanding the examples of the present disclosure so as not to obscure the disclosure with details that will be readily apparent to those of ordinary skill in the art having the benefit of the description herein.

### DETAILED DESCRIPTION

Call-takers at public safety answering points (PSAPs) that receive emergency calls prompt questions to the caller to gain a contextual understanding of an incident so that first responders can be accurately and efficiently dispatched to the incident. In some instances, however, it can be difficult for the call-taker to quickly acquire sufficient and accurate information for dispatching purposes. As one example, the caller may be unable to provide certain information about the incident, and the call-taker may instead need to rely on other information sources to obtain such information. As another example, the incident may be an evolving incident such that the characteristics of the incident, the information requested by the call-taker, and/or the answers provided by the caller change over time as the incident develops. In such scenarios, the call-taker may have insufficient information to use as a basis for dispatching resources to the incident scene, or the dispatched resources may become insufficient as the incident changes over time.

Thus, there is a need for improved mechanisms for enabling and assisting call-takers or other PSAP workers to alter or otherwise update the underlying incident data on which dispatch decisions are made, as well as the ultimate dispatching commands carried out based on the data. One example provides a method performed by a CAD system for dispatching resources to a scene of an incident. The method involves: (i) receiving, from a plurality of data sources, a collective dataset associated with the incident; (ii) displaying an interface comprising a plurality of data input fields, each of the data input fields configured to receive respective data associated with the incident; (iii) receiving, at a first data input field of the plurality of data input fields, a first user input comprising first data associated with the incident; (iv) receiving, via the user interface, a second user input comprising a request to create a data variable for a second data input field of the plurality of data input fields; (v) based on the second user input, (a) creating the data variable for the second data input field such that the value of the data variable is used as the value for the second data input field and (b) determining a data analytic for updating the value of the data variable; (vi) applying the data analytic to the collective dataset associated with the incident to determine an updated value of the data variable, and (vii) based on the first data and the updated value of the data variable, generating or updating a dispatch command for dispatching resources to the scene of the incident.

In some aspects of the method, the collective dataset associated with the incident comprises one or more of (i) a video feed of the incident, (ii) an audio feed of the incident, (iii) communications from one or more responding officers assigned to the incident, (iv) communications from a caller or texter reporting the incident, (v) sensor data from one or more sensors deployed at the scene of the incident, (vi) social media data associated with the incident, or (v) news report data associated with the incident.

In some aspects of the method, the second user input further comprises an indication of the data analytic for updating the value of the data variable, and wherein applying the data analytic comprises applying the data analytic indicated by the second user input.

In some aspects of the method, determining the data analytic for updating the value of the data variable comprises determining the data analytic based on one or more of (i) a type of data that the second data input field is configured to receive, (ii) a type of the incident, or (iii) a CAD identifier for the incident.

In some aspects of the method, the method further involves displaying the set of data associated with the incident, wherein the second user input comprises a selection of at least a portion of the displayed set of data.

In some aspects of the method, the method further involves: (i) determining a context of the selected portion of the displayed set of data; and (ii) based on the determined context, identifying the second data input field from among the plurality of data input fields as the data field corresponding to the request to create the data variable.

In some aspects of the method, determining the data analytic for updating the value of the data variable comprises determining the data analytic based on the determined context of the selected portion of the displayed set of data.

In some aspects of the method, receiving the second user input comprises receiving the second user input at the second data input field of the plurality of data input fields.

In some aspects of the method, the method further involves: (i) determining a time duration for the data variable; and (ii) automatically executing the generated dispatch command after the determined time duration.

In some aspects of the method, generating the dispatch command for dispatching resources to the scene of the incident comprises using the updated value of the data variable in a mathematical expression, and the method further involves: (i) displaying an indication of the mathematical expression; (ii) receiving a third user input comprising a request to edit the mathematical expression; and (iii) editing the mathematical expression based on the third user input, such that the generated dispatch command is determined using the edited mathematical expression.

Another example provides a CAD system for dispatching resources to a scene of an incident, the CAD system having at least one processor and a non-transitory computer-readable storage medium comprising program instructions that, when executed by the at least one processor, cause the CAD system to perform any or all aspects of the example method described above.

Still another example provides a non-transitory computer-readable storage medium comprising program instructions that, when executed by at least one processor, cause a CAD system to perform any or all aspects of the example method described above.

Each of the above-mentioned examples will be discussed in more detail below, starting with example system and device architectures of the system in which the examples may be practiced, followed by an illustration of processing blocks for achieving an improved technical method, device, and system for using data variables in a CAD system to intelligently dispatch resources during an evolving emergency incident.

Examples are herein described with reference to flowchart illustrations and/or block diagrams of methods, apparatus (systems and devices), and computer program products according to examples. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a special purpose and unique machine, such that the instructions, which execute via the processor of the computer or other programmable data processing apparatus, create means for implementing the operations specified in the flowchart and/or block diagram block or blocks. The methods and processes set forth herein need not, in some examples, be performed in the exact sequence as shown and, where possible, various blocks may be performed in parallel rather than in sequence. Accordingly, the elements of methods and processes are referred to herein as “blocks” rather than “steps.”

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions may also be loaded onto a computer or other programmable data processing apparatus that may be on or off-premises, or may be accessed via the cloud in any of a software as a service (Saas), platform as a service (PaaS), or infrastructure as a service (IaaS) architecture so as to cause a series of operational blocks to be performed on the computer or other programmable apparatus to produce a computer implemented process such that the instructions which execute on the computer or other programmable apparatus provide blocks for implementing the functions/acts specified in the flowchart and/or block diagram block or blocks. It is contemplated that any part of any aspect or example discussed in this specification can be implemented or combined with any part of any other aspect or example discussed in this specification.

Further advantages and features consistent with this disclosure will be set forth in the following detailed description, with reference to the figures.

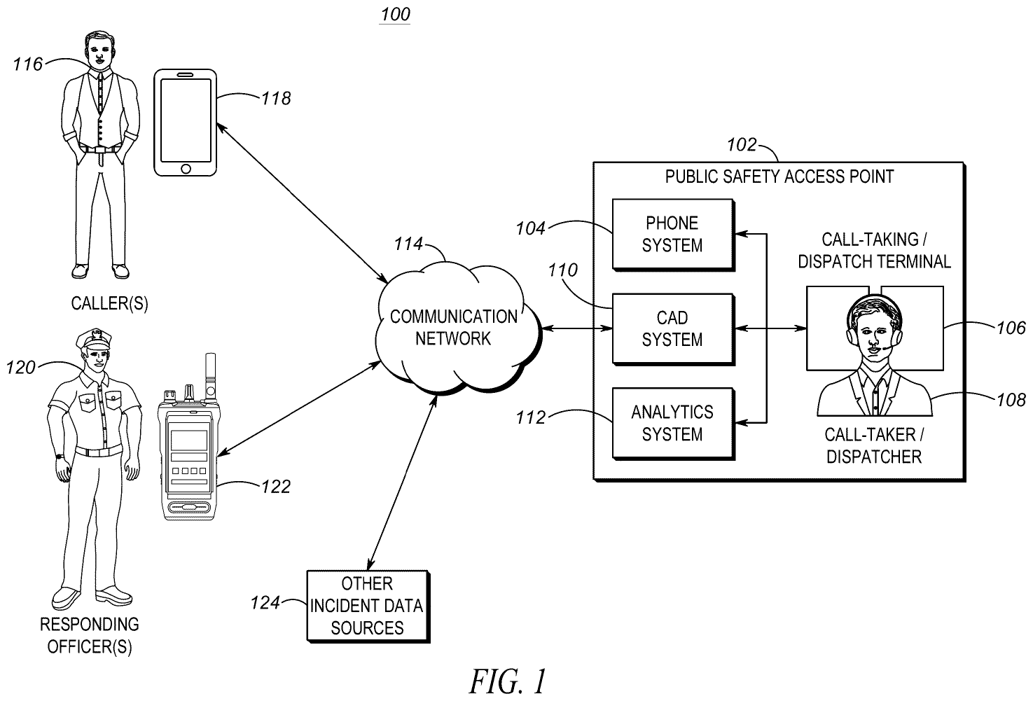

Referring now to the drawings, FIG. 1 illustrates an example public safety communications system 100. It should be understood that the system 100 is provided as one example and, in some instances, the system 100 may include fewer or additional components than those illustrated. As would be understood by one skilled in the art, FIG. 1 is a simplified diagram and, in practice, public safety communication systems can be more complex than the schematic elements depicted in FIG. 1.

In the illustrated example, the system 100 includes PSAP 102 (for example, an emergency call center) having a phone system 104, a call-taking/dispatching terminal 106, a call-taker/dispatcher 108 associated with the call-taking/dispatching terminal 106, a CAD system 110, and an analytics system 112. While illustrated for simplicity as including a single call-taking/dispatching terminal 106 and call-taker/dispatcher 108, it should be understood that the PSAP 102 may include multiple call-taking/dispatching terminals 106 and multiple call-takers/dispatchers 108. Further, in some examples of the PSAP 102, the call-taking and dispatching functions may be performed by disparate systems, such that the PSAP 102 includes separate call-taking and dispatching terminals as well as separate call-takers and dispatchers that interface with such terminals. Additionally, while illustrated for simplicity as a single analytics system 112 residing at the PSAP 102, the analytics system 112 may alternatively be implemented in a distributed manner at the PSAP 102. In some instances, the analytics system 112 is implemented in whole or in part by a cloud computing environment accessible by the PSAP 102.

The PSAP 102 is communicatively connected to a communication network 114 and performs, among other things, CAD operations to provide emergency services to callers, such as the caller 116 illustrated in FIG. 1. The call-taking/dispatching terminal 106 includes, among other things, a processor (for example, a microprocessor or another suitable programmable device), a memory (i.e., a computer-readable storage medium), and one or more input devices, output devices, or input and output devices including, for example, one or more displays, keyboards, keypads, mice, joysticks, touchscreens, speakers, microphones, and/or headsets. Various other components of the PSAP 102, such as the phone system 104, the CAD system 110, and the analytics system 112 can similarly include a processor and a memory storing program instructions executable by the processor to perform the operations described herein.

The components of the PSAP 102 are communicatively coupled using one or more wired and/or wireless networks. A call-taker/dispatcher 108 interacts with the call-taking/dispatching terminal 106 to answer communications, including emergency calls (e.g., 9-1-1 calls) made to and received at the PSAP 102. For example, a caller 116, using a communication device 118 (e.g., a telephone, a smart telephone, a tablet computer, or another similar device capable of operating as described herein) places an emergency call using the communication network(s) 114 (e.g., a cellular network, the public switched telephone network, the Internet, or another suitable network), and the call is routed to the PSAP 102.

The phone system 104 routes calls received from callers, such as the caller 116, over the communication network(s) 114 to the call-taking/dispatching terminal 106 so that the call-taker/dispatcher 108 may respond to the call. The call may be a voice-based call (e.g., a telephone call, a video call including audio, an audio recording sent via text-to-9-1-1, etc.) or a text-based call (e.g., a multimedia messaging service (MMS) message, a short message service (SMS) message, a real-time text (RTT) message, etc.). As such, while the present disclosure primarily refers to the caller 116 as a “caller,” it should be understood that the term “caller” is meant to encompass examples where the emergency call is a text-based call.

In addition to routing the call to the call-taker/dispatcher 108 via the call-taking/dispatching terminal 106, the phone system 104 provides call content and other information associated with the call (e.g., a phone number of the caller 116, a caller ID of the caller 116, a location of the caller 116, and/or the like) to the analytics system 112. The analytics system 112 is configured to analyze the call content and other information associated with the call and to perform various functions based on the performed analyses. For example, as explained in further detail below, the analytics system 112 can be configured to perform speech recognition with respect to the call content (e.g., using a natural language model or the like) and generate a transcript of the call.

The call-taker/dispatcher 108 further interacts with the call-taking/dispatching terminal 106 to dispatch one or more responding officer(s) 120 to respond to the emergency incident for which the caller 116 is calling. For example, the call-taker/dispatcher 108 inputs information identifying the types and number of responding officer(s) 120 to be dispatched. The call-taking/dispatching terminal 106 provides this information to the CAD system 110, which then sends a dispatch alert to the mobile device(s) 122 of the responding officer(s) 120 via the communication network(s) 114. The dispatch alert may include information about the incident, such as the incident location, incident type, and identifying information of the caller 116.

The CAD system 110 routes information between the call-taking/dispatching terminal 106 and the mobile device(s) 122 of the responding officer(s) 120 over the communication network(s) 114. In some examples, the routed information includes voice communications between the responding officer(s) 120 and the call-taker/dispatcher 108. In this regard, the mobile device(s) 122 may include a land mobile radio, and the CAD system 110, the communication network(s) 114, and the mobile device(s) 122 may operate according to a land mobile radio protocol, such as the Project 25 (P25) standard developed by the Association of Public-Safety Communications Officials (APCO), the Terrestrial Trunked Radio (TETRA) specification, the Digital Mobile Radio (DMR) standard, the Next Generation Digital Narrowband (NXDN) standard, the Digital Private Mobile Radio (dPMR) standard, and/or the OpenSky standard.

The information routed between the call-taking/dispatching terminal 106 and the mobile device(s) 122 of the responding officer(s) 120 over the communication network(s) 114 may take various other forms as well. For instance, the mobile device(s) 122 can include a media capture device, such as a microphone and/or camera (e.g., body-worn camera) configured to capture audio and/or of the surroundings of the responding officer(s) 120. In this regard, the mobile device(s) 122 may capture audio and/or video of interactions between the responding officer(s) 120 and the caller 116 or any other individual at the incident scene. To provide this captured data to the PSAP 102, the CAD system 110, the communication network(s) 114, and the mobile device(s) 122 may operate according to a broadband wireless link protocol suitable for transmitting this audio and/or video data, such as the Institute of Electrical and Electronics Engineers (IEEE) 802.11 standard (Wi-Fi), the IEEE 802.16 standard (WiMAX), the Long Term Evolution (LTE) standard, the 5G New Radio (NR) standard, the Code Division Multiple Access 2000 (CDMA2000) standard, the Evolved Packet Core (EPC) standard, and/or one or more satellite broadband protocols.

The CAD system 110 provides the information routed between the call-taking/dispatching terminal 106 and the mobile device(s) 122 of the responding officer(s) 120 to the analytics system 112, and the analytics system 112 uses this information to assist in automatically updating data associated with the incident as well as generating dispatch commands, as explained in further detail below.

The analytics system 112 can also receive information from various other incident data sources 124 to assist in automatically updating data associated with the incident as well as generating dispatch commands. The other incident data sources 124 can include any data sources capable of providing information about the incident to the analytics system 112. Examples of such data sources 124 can include fixed or mobile video cameras capturing video and/or audio data of the incident, human-created or machine-created descriptions or alerts based on the captured video and/or audio, biometric sensors configured to measure various biometric characteristics of the responding officers 120 and/or other individuals at the incident scene, weather sensors, air quality sensors, gas detectors, fire/smoke detectors, acoustic sensors (e.g., gunshot or explosion detectors), IoT devices, or social media data sources. These other incident data sources 124 can likewise provide information about the incident over the communication network 114 to the analytics system 112 for use in automatically updating data associated with the incident and generating dispatch commands.

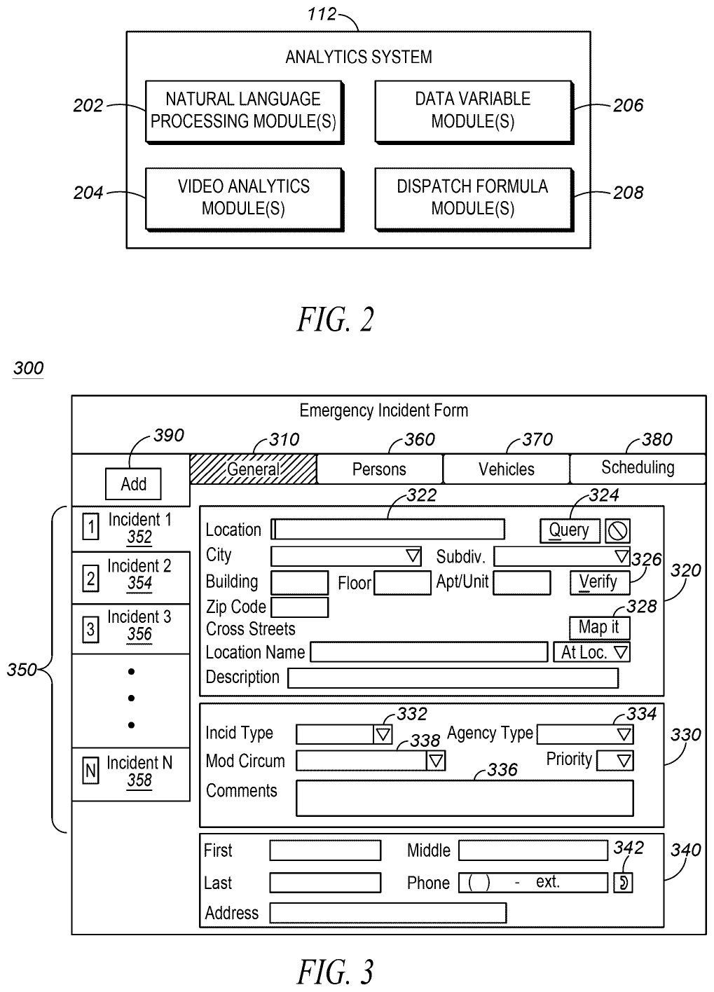

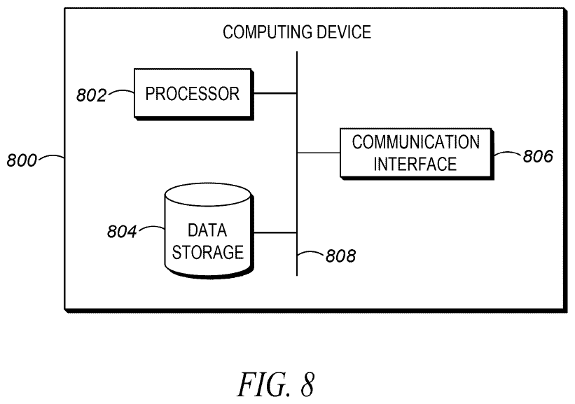

FIG. 2 schematically illustrates one example of the analytics system 112. The analytics system 112 can be a computer server located on the premises of, or remote from, the PSAP 102. For example, some or all functionality of the analytics system 112 may be cloud-implemented and accessible by the PSAP 102. In the example illustrated, the analytics system 112 includes one or more natural language processing (NLP) modules 202, one or more video analytics modules 204, one or more data variable modules 206, and one or more dispatch formula modules 208. Some or all of these modules can be implemented as software modules executed by a computing device, such as the computing device 800 depicted in FIG. 8 and described in further detail below. Further, while FIG. 2 depicts each module as a separate discrete module, it should be understood that the functionality of each depicted module can be combined into fewer modules (e.g., a single module), or extended across additional or different modules.

The NLP module 202 is configured to employ any currently known or later developed techniques for processing, analyzing, and interpreting human language data. For example, the NLP module 202 can operate by initially preprocessing input text to segment it into discrete tokens, which may represent words or phrases. Each token can be correlated with a corresponding part of speech. Named entities within the text, such as individuals and locations, are identified and classified. Syntactic and semantic analyses are performed to ascertain the relationships between the tokens. The NLP module 202 can employ advanced machine learning models trained on extensive datasets to capture and interpret contextual nuances and the intent of the language. This comprehensive approach enables the NLP module 202 to accurately extract information and interpret the context of a conversation and, when employed by the analytics system 112 in connection with text data associated with a public safety incident, enables the analytics system 112 to automatically identify and extract information about the public safety incident from the text data. This information can then be used to improve dispatching decisions, as explained in further detail below.

The video analytics module 204 is configured to employ any currently known or later developed techniques for real-time or near real-time identification and analysis of characteristics pertaining to ongoing events within a video feed. For example, the video analytics module 204 can preprocess a video feed by segmenting it into discrete frames. Each frame can be processed using object detection algorithms, such as convolutional neural networks (CNNs) or other machine learning models trained on extensive datasets. Such algorithms can be configured to identify and classify subjects, such as people, vehicles, or other predefined objects of interest. This information can then be used to improve dispatching decisions, as explained in further detail below.

The data variable module 206 is configured to create and update values of data variables for use in connection with determining and documenting characteristics of an emergency incident, as well as for dispatching resources to the scene of the incident. For example, each data variable created by the data variable module 206 may correspond to a particular numerical characteristic of an emergency incident, such as a number of people (e.g., victims, perpetrators, witnesses) associated with the incident, a number of vehicles involved in the incident, a number of weapons detected at the incident scene, a size of an area associated with the incident, such as the number of floors or square footage of a building or a measurement of the physical arca encompassed by the incident. The data variable module 206 creates a representation of the variable, such as a variable name, and stores the representation in a computer-readable storage medium along with a current value of the variable. As explained in further detail below, the data variable module 206 is further configured to update the current value of the variable based on data analyses performed by the NLP module 202 and the video analytics module 204.

The dispatch formula module 208 is configured to create and evaluate mathematical expressions that use the data variables created by the data variable module 206 to automatically generate recommended dispatch commands for dispatching resources to the scene of the incident. The expressions can be predefined, user-created, and/or user-customizable expressions and may vary depending on characteristics of the emergency incident, such as a type of the incident. Further, in some examples, the dispatch formula module 208 may be configured to automatically generate and/or recommend a particular expression based on predefined rules or using a machine learning model trained on a dataset that includes historic dispatching commands and/or historic user-defined expressions.

As will be explained in further detail below, the NLP module 202, the video analytics module 204, the data variable module 206, and the dispatch formula module 208 of the analytics system 112 are capable of operating in connection with and improving upon conventional CAD systems, which provide emergency incident forms through which the call-taker/dispatcher 108 can input emergency incident information and dispatch commands.

Referring now to FIG. 3, an example emergency incident form 300 is illustrated. The emergency incident form 300 provides an interface through which the call-taker/dispatcher 108 can input information characterizing, or otherwise associated with, an emergency incident. The call-taker/dispatcher 108 can input such information based on information gleaned from the caller 116, any officers 120 located at the scene of the incident, and/or any of the other incident data sources 124.

As shown in FIG. 3, the emergency incident form 300 includes several layers of form-fillable information including a plurality of data input fields organized within a plurality of form tabs. For example, a general tab 310 includes data input fields that allow the call-taker 108 to input incident location information 320, such as by entering the street address or landmark address into data input field 322. Additionally or alternatively, the call-taker 108 can input a city or subdivision, building number, floor number, apartment or unit number, or zip code into the data input fields of the incident location information 320. The call-taker 108 can look-up the inputted location address by selecting a query button 324 (e.g., to determine that the address exists), verify the address by selecting a verify button 326 (e.g., to determine if a dwelling or business is located at the address as opposed to a vacant lot), or map the address by selecting a map it button 328. The map it button 328 can access a locally stored map program or a remote global positioning satellite-based map program to obtain and display a map of the specific location of the emergency incident. Additional information can also be input into the data input fields of the incident location information 320, such as a location name (e.g., victim's home, location of the accident or crime, and the like) together with additional location description, as well as an indication of whether the citizen is still at the incident location.

As further shown in FIG. 3, the general tab 310 can also include one or more data input fields adapted to receive input related to incident type information 330. For example, an incident type label (e.g., crime, fire, accident, alarm activation, and the like) can be specified by selecting the type label from an incident type drop-down menu 332. A recommended responding agency type (e.g., police, fire, EMS, and the like) can be specified by selecting the agency type from an agency type drop-down menu 334. Comments about the incident, such as a summary of the caller's description of the incident, can be entered into an incident comment data input field 336. Additional comments can be added as the incident progresses over time, and a change in the incident can be indicated by selecting an option from a modify circumstances drop-down menu 338.

Still further, the general tab 310 can also include one or more data input fields adapted to receive input related to caller identification information 340. For example, as shown, the caller identification data input fields 340 can include data input fields for receiving the first name, middle name, surname, address, and telephone number of the caller 116. The general tab 310 can further include a call button 342 that, when selected, causes the phone system 104 to call the telephone number of the caller 116 (e.g., when the emergency call is disconnected or when the caller 116 is engaged an emergency text message dialogue with the call-taker 108).

Once the call-taker/dispatcher 108 has entered incident data into the emergency incident form 300, the call-taker/dispatcher 108 can select an incident add button 390, which causes the CAD system 110 to assign a unique incident number to the emergency incident. As shown, the emergency incident form 300 can be one of multiple pending emergency incident forms 350 corresponding to a plurality of pending emergency incidents. For example, the pending emergency incident forms 350 can include a first incident form 352, a second incident form 354, a third incident form 356, and any additional incident forms up to a predetermined maximum number of incident forms 358 as determined by program settings.

Additional optional tabs such as a person tab 360, vehicle tab 370 and a schedule tab 380 can be provided and associated to each emergency incident form. For example, additional victims, perpetrators or witnesses can be input into a plurality of data input fields providing names, address, telephone numbers, and physical descriptions of those individuals. In the event of a car accident or stolen vehicle, vehicle description information such as the make, model, year, color, and license tags can be input into a plurality of data input fields under the vehicle tab 370. A scheduling tab 380 can be provided in the event of a situation where a citizen requests a police patrol at a specific time of the day or night.

Based on the information input into the emergency incident form 300, the call- taker/dispatcher 108 can decide to dispatch certain resources (e.g., responding officers 120, police vehicles, ambulances, fire engines, etc.) to the scene of the incident, such as by providing one or more dispatch commands to the CAD system 110. However, as noted above, there may be instances where the call-taker/dispatcher 108 may be lacking sufficient information to use as a basis for dispatching resources to the incident scene, or where the evolving nature of the incident causes the previously-received information about the incident to become erroneous, thereby causing previously-dispatched resources to become insufficient as the incident changes over time.

In order to provide improved outcomes when making dispatching decisions for responding to an emergency incident, the present disclosure provides systems and methods for creating data variables that correspond to certain data input fields of the emergency incident form 300 provided by the CAD system 110, updating the values of the data variables over time as new information about the incident is obtained, and generating dispatch commands based on the values of the data variables. Examples are described in further detail below.

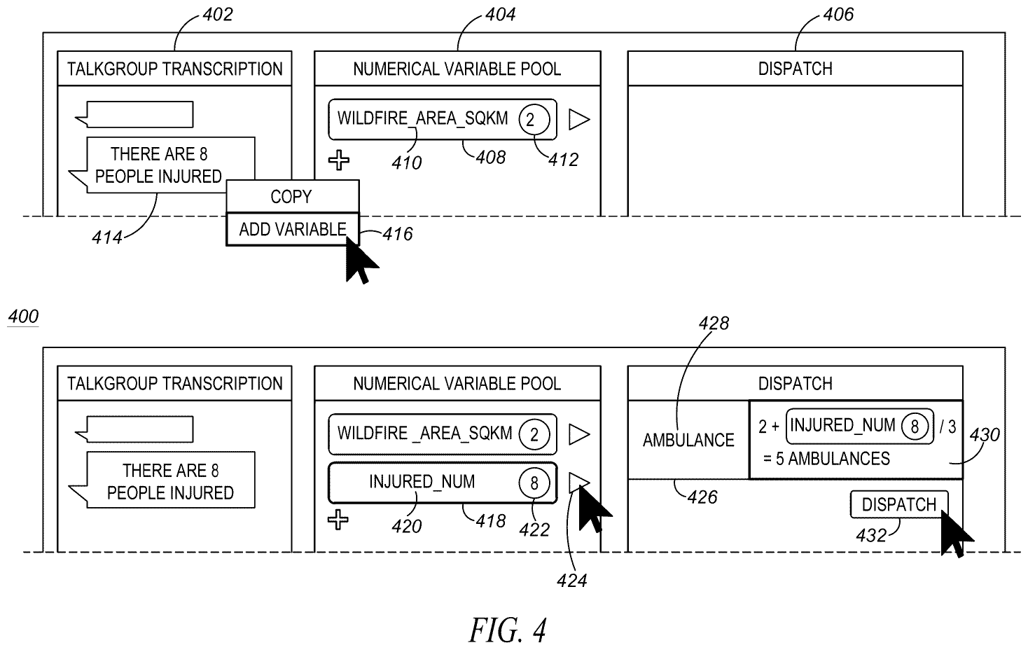

FIG. 4 illustrates an example user interface 400 for creating and updating a data variable in a CAD system. The user interface 400 may be provided by the CAD system 110 and may be part of the same user interface for providing the emergency incident form 300, or the user interface 400 may be a separate user interface.

As depicted, the user interface 400 includes three display areas. The first display area is an incident data display area 402 where data associated with the emergency incident is displayed. In the present example, the incident data display area 402 includes a transcription of a talkgroup conversation among the responding officers 120. However, this is for illustrative purposes only, and the incident data display area 402 can include any other data associated with the emergency incident, such as the emergency incident form 300, a transcription of a 9-1-1 call associated with the incident, or a visual depiction of any of the incident data received by the analytics system 112 as described above (e.g., data from the responding officers 120 and/or the other incident data sources 124).

The second display area is a numerical variable display area 404. The numerical variable display area 404 includes a list of the data variables that have been created for the emergency incident. In the depicted example, the emergency incident is an ongoing wildfire, and the numerical variable display area 404 includes a first data variable 408 corresponding to the area of the wildfire in square kilometers. Each data variable in the numerical variable display area 404 is identified by its variable name 410 and its value 412.

The third display area is a dispatch command display area 406. As explained in further detail below, the dispatch command display area 406 includes dispatch commands generated by the analytics system 112 using the data variables from the numerical variable display arca 404.

In operation, the user interface 400 can provide various mechanisms by which the call-taker/dispatcher 108 can create new data variables for inclusion in the numerical variable display area 404, as well as create new dispatch commands for inclusion in the dispatch command display area 406. FIG. 4 depicts one such example. In the depicted example, the call-taker/dispatcher 108 creates a new data variable by interacting with the incident data display arca 402. Namely, the call-taker/dispatcher 108 interacts with a selected portion of text 414 from the transcribed talkgroup conversation (e.g., by using a mouse and cursor to right-click on the portion of text 414). This interaction causes the user interface 400 to present an add variable menu option 416, the selection of which results in the creation of a second data variable 418 corresponding to a number of injured people at the incident scene.

The analytics system 112 can be configured to intelligently create data variables with minimal input from the call-taker/dispatcher 108. For example, when creating the second data variable 418, the NLP module 202 can process the selected portion of text 414 in the talkgroup transcription to infer its context and extract data from the text 414. Namely, in the present example, the NLP module 202 can determine that the selected portion of text 414 refers to a number of injured people and that the value of the number of injured people is eight. Based on this determination, the data variable module 206 creates the second data variable 418 by creating a variable name 420 and storing the extracted data variable value 422 in association with the variable name 420. The data variable module 206 can create the variable name 420 by selecting the name 420 from a set of predetermined variable names, each of which may correspond to a particular context determined from the command to create the second data variable 418. For instance, because the NLP module 202 determined in the depicted example that the selected portion of text 414 refers to a number of injured people, the data variable module 206 can assign a predetermined variable name that is associated with a number of injured people. In other examples, the data variable module 206 can newly generate the variable name 420 and may similarly use the determined context of the selected portion of text 414 to assign a variable name 420 that reflects the determined context. In the depicted example, the data variable module 206 assigns “INJURED_NUM” as the variable name 420 based on the determination that the selected text 414 refers to a number of injured people.

Once the data variable module 206 has created the data variable 418, the analytics system 112 employs one or more data analysis algorithms to monitor data associated with the incident for purposes of updating the value of the data variable 418. In some examples, the employed algorithms and/or the scope of the monitored data may depend on the context of the incident and/or the creation of the data variable 418. For instance, because the data variable 418 was created using the selected text 414 in the talkgroup transcription, the analytics system 112 can default to causing the NLP module 202 to monitor the same data source (i.e., the talkgroup transcription) to detect new information regarding the value of the data variable 418 (e.g., by identifying a more recent discussion of the number of injured people in the talkgroup transcription). And in response to detecting such new information, the analytics system 112 can then cause the data variable module 206 to update the value 422 of the data variable 418 to reflect this new information. In some examples, the analytics system 112 can expand the scope of the data analytics to other data sources. For example, the analytics system 112 can cause the video analytics module 204 to analyze video footage from the incident scene (e.g., from body-worn cameras of the responding officers 120, from fixed video cameras at the incident scene, and/or from any of the other incident data sources 124) to detect and count the number of injured people on scene. In each of these examples, the analytics system 112 can intelligently choose the analytics algorithms and the incident data to which the algorithms are applied based on various aspects, such as the type of the incident, the context of the creation of the data variable 418, and the historical usage of analytics for updating other similar historical data variables.

When the call-taker/dispatcher 108 wants to activate a variable in the numerical variable display area 404 for use in a mathematical expression for generating a dispatch command, the call-taker/dispatcher 108 can select an activation icon 424 for the variable. As depicted, selecting the activation icon 424 causes the dispatch formula module 208 to add a new dispatch command 426 to the dispatch command display area 406. The dispatch command 426 identifies the resource type 428 that is to be dispatched, as well as the mathematical expression 430 used to calculate the quantity of dispatched resources.

The dispatch formula module 208 can generate the mathematical expression 430 in various ways. In some examples, the dispatch formula module 208 selects the mathematical expression 430 from a set of predefined expression. Each predefined expression may correspond to a particular type of dispatched resource, a particular type of incident, and/or a particular type of variable. In some examples, the dispatch formula module 208 may allow the call-taker/dispatcher 108 to define the expression 430 by way of user input. In some examples, the dispatch formula module 208 may intelligently generate the mathematical expression 430, such as by using a machine learning model that has been trained on extensive datasets of historical mathematical expressions and their corresponding resource types, incident types, and/or variable types. In the depicted example, the dispatch formula module 208 generates the mathematical expression 430 such that a minimum number of two ambulances are dispatched, and an additional ambulance is dispatched for every three injured persons detected at the incident scene.

Once the dispatch formula module 208 has generated the mathematical expression 430 for dispatching resources to the incident scene, the call-taker/dispatcher 108 can execute the dispatch command by selecting the dispatch icon 432. Upon selection of the dispatch icon 432, the CAD system 110 sends dispatch instructions to the appropriate responding officers 120 for dispatching the number of resources specified by the mathematical expression 430. In the depicted example, the mathematical expression 430 specifies the dispatching of five ambulances, so the CAD system 110 sends dispatching instructions to five ambulance crews.

Additionally, even after sending the dispatch instructions, the CAD system 110 can continue to utilize the analytics system 112 to supplement the emergency response with additional dispatch instructions as needed. For instance, continuing with the example depicted in FIG. 4, the analytics system 112 can continue to monitor the incident data to evaluate whether there have been any changes to the number of injured people and responsively update the value 422 of the data variable 418. If the value increases enough to change the number of dispatched ambulances specified by the mathematical expression 430, then the CAD system 110 can responsively transmit an additional dispatch instruction to additional ambulance crews, as dictated by the expression 430. This process can be carried out automatically and continuously, such that a sufficient and accurate number of resources are dispatched to the incident scene without any additional intervention by the call-taker/dispatcher 108.

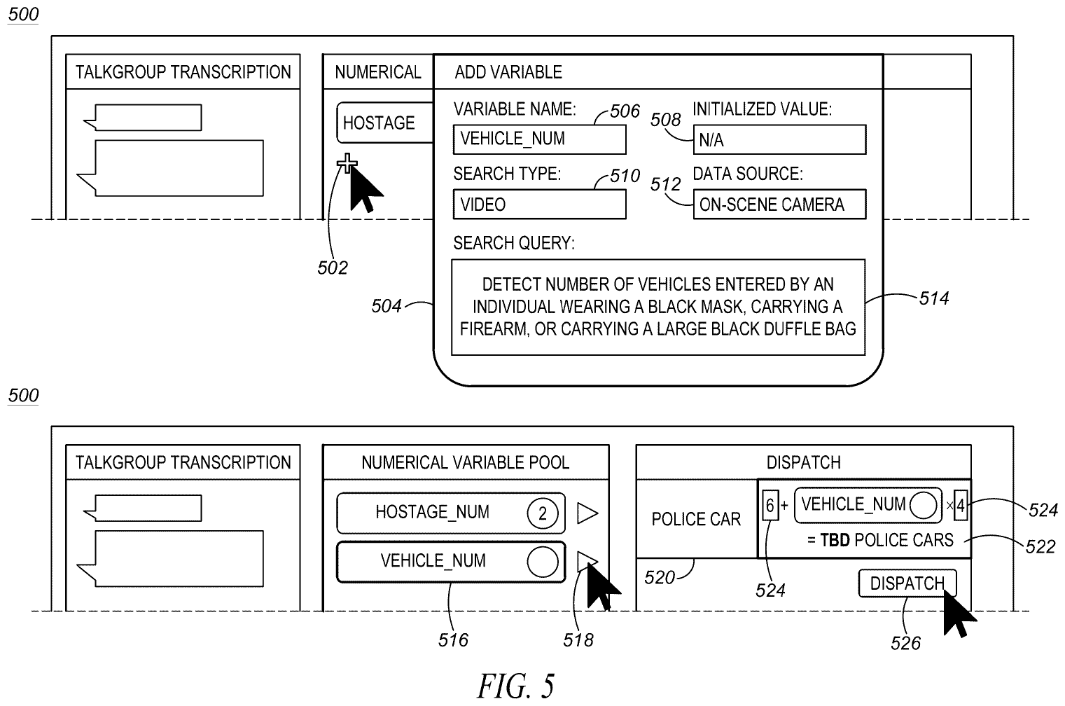

FIG. 5 illustrates another example user interface 500 for creating and updating a data variable in a CAD system. The user interface 500 is generally the same as the user interface 400 depicted in FIG. 4. However, FIG. 5 depicts the user interface 500 in connection with a different emergency incident and depicts additional ways for creating and updating the data variable. As depicted, the user interface 500 provides functionality for dispatching resources to the scene of a hostage situation. In order to create a new data variable, the call-taker/dispatcher 108 selects the add variable icon 502, which causes the user interface 500 to display an add variable menu 504 that includes a number of input fields for specifying aspects of the data variable to be created, as well as the analytics for updating the value of the data variable. For instance, the add variable menu 504 includes (i) a variable name input field 506 in which the call-taker/dispatcher 108 can specify the name of the data variable, (ii) an initialized value input field 508 in which the call-taker/dispatcher 108 can specify an initial or default value of the data variable, (iii) a search type input field 510 in which the call-taker/dispatcher 108 can specify the type of data to be analyzed and/or the type of analytic algorithm to be applied when updating the value of the data variable, (iv) a data source input field 512 in which the call-taker/dispatcher 108 can specify one or more specific data sources to be analyzed when updating the value of the data variable, and (v) a search query input field 514 in which the call-taker/dispatcher 108 can specify the target subject(s) that the data analytics are meant to detect and count.

Once the call-taker/dispatcher 108 has input the relevant information into the add variable menu 504, the data variable module 206 uses the input information to create a new data variable 516 having the specified variable name and initialized value, and the video analytics module 204 uses the input information to update the value of the data variable 516 by performing the specified search query on the specified data source(s).

Similar to the example depicted in FIG. 4, the call-taker/dispatcher 108 can activate the variable 516 for use in a mathematical expression for generating a dispatch command by selecting an activation icon 518 for the variable 516. As depicted, selecting the activation icon 518 causes the dispatch formula module 208 to generate a new dispatch command 520.

However, the generated dispatch command 520 in FIG. 5 differs from the generated dispatch command 426 in FIG. 4 in that the generated dispatch command 520 in FIG. 5 is editable on the fly by the call-taker/dispatcher 108. As shown, the command 520 includes an editable mathematical expression 522, which contains editable fields 524, such that the call-taker/dispatcher 108 can change the numerical values in the editable fields 524, thereby changing the number of dispatched resources calculated by the mathematical expression 522. While the present example depicts limiting the editing of the mathematical expression 522 to a specified set of editable fields 524, in other examples, the mathematical expression 522 can be fully customizable. For instance, in some examples, the call-taker/dispatcher 108 can change any numerical values, operators, and/or variables in the mathematical expression 522. Further, in some examples, the call-taker/dispatcher 108 can change or specify the type of dispatched resource, which in the present example is a police car.

Once the call-taker/dispatcher 108 has finished editing the dispatch command 520, the call-taker/dispatcher 108 can select the dispatch icon 526, which causes the CAD system 110 to execute the dispatch command 520 in accordance with the mathematical expression 522 and in the manner described above.

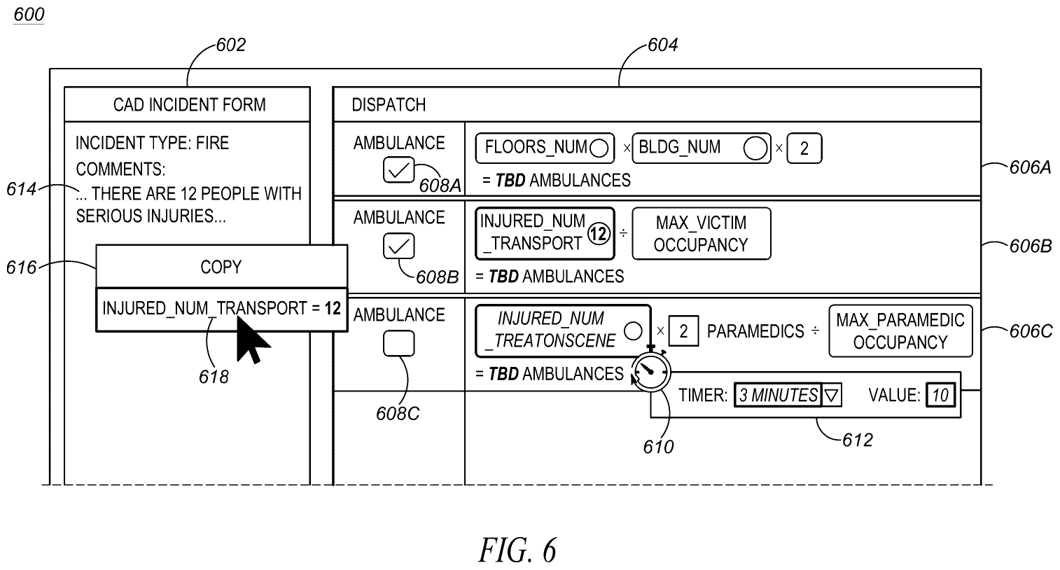

FIG. 6 illustrates yet another example user interface 600 for creating and updating data variables in a CAD system. The user interface 600 generally provides the same functionalities as the user interfaces depicted in FIGS. 4 and 5. For simplification purposes, the user interface 600 in FIG. 6 only includes a depiction of an incident data display area 602 and a dispatch command display area 604, but does not include a depiction of the numerical variable display 404. However, it should be understood that the user interface 600 can include this same functionality in practice.

As shown in FIG. 6, the incident data display area 602 includes a CAD incident form, which may be the same form as the emergency incident form 300 described above in connection with FIG. 3 (although depicted in a much more condensed form in FIG. 6 for simplification purposes). Similar to the discussion above in connection with FIG. 4, the call-taker/dispatcher 108 can interact with a portion of text 614 in the incident data display area 602, such as by right-clicking on the portion of text 614. This interaction causes the user interface 600 to display an add variable menu 616. However, in the depicted example, the add variable menu 616 includes a preview 618 of the variable that the analytics system 112 will create based on the selected text 614. Selecting the variable preview 618 causes the data variable module 206 to create the variable identified by the variable preview 618 in the manner described above. In the present examples, the created variable corresponds to the number of seriously injured people at the incident scene who need to be transported for medical treatment.

Continuing with the example in FIG. 6, the dispatch command display area 604 includes three separate dispatch commands 606, including a first dispatch command 606A, a second dispatch command 606B, and a third dispatch command 606C, and the call-taker/dispatcher 108 can separately edit and execute each of the commands 606. For instance, the call-taker/dispatcher 108 can cause the CAD system 110 to execute an individual command 606 by selecting the individual command's activation icon 608. In the depicted example, the call-taker/dispatcher 108 has selected the first activation icon 608A of the first dispatch command 606A as well as the second activation icon 608B of the second dispatch command 606B, but has not selected the third activation icon 608C of the third dispatch command 606C. As a result, the CAD system 110 will execute the first and second dispatch commands 606A/606B but will refrain from executing the third dispatch command 606C. Further, in some examples, certain ones of the dispatch commands 606 may be automatically activated using rule-based algorithms tailored to enforce agency policies and/or using machine-learning models trained on extensive datasets of prior activated dispatch commands.

In addition to providing separate activation icons 608 for individually activating dispatch commands 606, the dispatch command display area 604 can also provide a timer functionality for delaying the execution of a dispatch command. As shown, an unexecuted dispatch command, such as the third dispatch command 606C, can include a timer icon 610. Selecting the timer icon 610 causes the user interface 600 to display a timer menu 612 through which the call-taker/dispatcher 108 can specify a duration of the timer as well as a default value for the mathematical expression of the dispatch command 606C. When the timer duration expires, the CAD system 110 is configured to execute the dispatch command 606C using the specified default value of the mathematical expression when dispatching the resources identified by the dispatch command 606C. With this arrangement, the call-taker/dispatcher 108 can ensure that at least the specified number of resources will be dispatched when the timer expires, which can be useful in situations where the analytics system 112 is unable to update the value of a variable that results in the dispatching of resources.

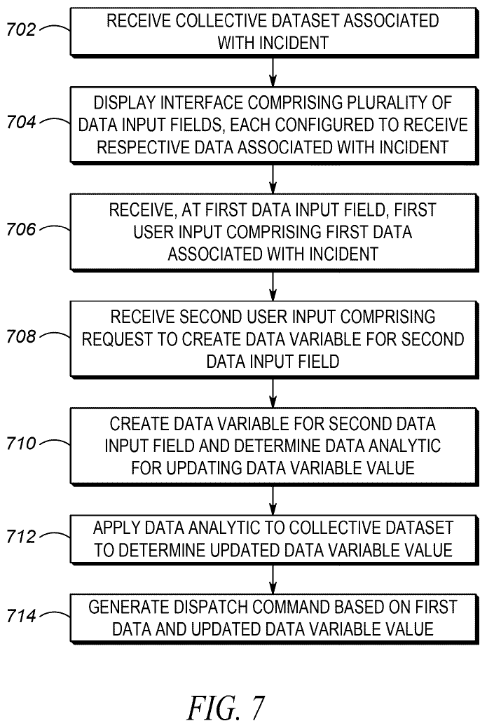

FIG. 7 illustrates an example method 700 implemented by the PSAP 102. Different aspects of the method 700 can be carried out by different components of the PSAP 102, where applicable. For instance, aspects of the method 700 that involve interfacing with a call-taker can be carried out by the call-taking/dispatching terminal 106, aspects of the method 700 that involve data analysis can be carried out by the analytics system 112, and aspects of the method 700 that involve carrying out dispatch commands can be performed by the CAD system 110. However, it should also be understood that the PSAP 102 can carry out the method 700 in any other manner consistent with the present disclosure.

At block 702, the method 700 involves receiving, from various data sources, a collective dataset associated with an emergency incident. As noted above, this may involve the analytics system 112 receiving incident data from the phone system 104 (e.g., audio or a transcription of the emergency call from the caller 116), from the responding officers 120, and/or from any of the other incident data sources 124. As such, the dataset associated with the incident can include one or more of (i) a video feed of the incident, (ii) an audio feed of the incident, (iii) communications from one or more responding officers assigned to the incident, (iv) communications from a caller reporting the incident, (v) sensor data from one or more sensors deployed at the scene of the incident, (vi) social media data associated with the incident, or (v) news report data associated with the incident.

At block 704, the method 700 involves displaying an interface having a number of data input fields, each of the data input fields being configured to receive respective data associated with the incident. In line with the discussion above, this may involve the call-taking/dispatch terminal 106 displaying an emergency incident form, such as the emergency incident form 300 depicted in FIG. 3.

At block 706, the method 700 involves receiving, at a first data input field of the emergency incident form, a first user input comprising first data associated with the incident. In line with the discussion above, this may involve the call-taker/dispatcher 108 manually inputting data into the emergency incident form 300.

At block 708, the method 700 involves receiving a second user input comprising a request to create a data variable for a second data input field of the emergency incident form. In line with the discussion above, this may involve the call-taker/dispatcher 108 interacting with a portion of text in the emergency incident form and/or one of the data input fields of the emergency incident form to create a corresponding variable, or this may involve the call-taker/dispatcher 108 selecting an add variable icon and specifying the parameters of the variable.

At block 710, the method 700 involves, based on the second user input, (i) creating the data variable for the second data input field such that the data variable is used as the value for the second data input field and (ii) determining a data analytic for updating the value of the data variable. In line with the discussion above, the data variable module 206 can create the variable, and the analytics system 112 can determine the data analytic in various ways. In some examples, the analytics system 112 infers the data analytic based on one or more of (i) a type of data that the second data input field is configured to receive, (ii) a type of the incident, or (iii) a CAD identifier for the incident. In some examples, the second user input further includes an indication of the data analytic for updating the value of the data variable, and applying the data analytic involves applying the data analytic indicated by the second user input.

At block 712, the method 700 involves applying the data analytic to the collective dataset associated with the incident to determine an updated value of the data variable. In line with the discussion above, this may involve the NLP module 202 and/or the video analytics module 204 applying the data analytic to the dataset to determine an updated value of the data variable.

At block 714, the method 700 involves, based on the first data and the updated value of the data variable, generating or updating a dispatch command for dispatching resources to the scene of the incident. In line with the discussion above, this may involve using the updated value of the data variable in a mathematical expression, and the method 700 can further involve: (i) displaying an indication of the mathematical expression, (ii) receiving a third user input comprising a request to edit the mathematical expression, and (iii) editing the mathematical expression based on the third user input, such that the generated or updated dispatch command is determined using the edited mathematical expression.

Further, in some examples, the method 700 can further involve (i) determining a time duration for the data variable and (ii) automatically executing the generated or updated dispatch command after the determined time duration.

In the examples described above, certain functionalities are described as involving user inputs or being carried out in response to user inputs. It should be understood that, in some examples, the user inputs may be replaced with automated machine-based determinations. For instance, in some examples, the analytics system 112 can automatically make a determination to create a data variable based on an evaluation of the incident data received by the analytics system 112. Such a determination could be made based on a machine-learning algorithm trained on extensive datasets of prior human-based user inputs for creating data variables. Similar machine-learning based automations can be applied to the other user inputs described above as well.

Attention is next directed to FIG. 8, which depicts a schematic block diagram of an example computing device 800. The computing device 800 may represent a structure of any suitable component of the public safety communications system 100, including, but not limited to, the PSAP 102, the phone system 104, the call-taking/dispatching terminal 106, the CAD system 110, the analytics system 112, the mobile device 118 of the caller 116, and the mobile devices 122 of the responding officers 120. While the computing device 800 is depicted in FIG. 8 as a single component, when the computing device 800 represents a structure of the public safety communications system 100, functionality of the computing device 800 may be distributed among a plurality of components. Further, in such examples, functionality of the PSAP 102, the phone system 104, the call-taking/dispatching terminal 106, the CAD system 110, the analytics system 112, the mobile device 118 of the caller 116, and the mobile devices 122 of the responding officers 120 may be combined in any suitable manner.

As depicted, the computing device 800 includes at least a processor 802, a data storage 804, and a communication interface 806, all of which may be communicatively linked by a communication link 808, which may take the form of a system bus or some other connection mechanism.

The processor 802 may comprise one or more processor components, such as general-purpose processes (e.g., a single-or multi-core microprocessor), special-purpose processors (e.g., an application-specific integrated circuit or digital-signal processor), programmable logic devices (e.g., a field programmable gate array), controllers (e.g., microcontrollers), and/or any other processor components now known or later developed.

The data storage 804 may comprise one or more non-transitory computer-readable storage mediums, examples of which may include volatile storage mediums such as random-access memory, registers, cache, etc. and non-volatile storage mediums such as read-only memory, a hard-disk drive, a solid-state drive, flash memory, an optical-storage device, etc. The data storage 804 may also be provisioned with software components that enable the computing device 800 to carry out the operations disclosed herein. These software components may generally take the form of program instructions that are executable by the processor 802 to carry out the disclosed operations.

The communication interface 806 may be configured to facilitate wired and/or wireless communication with other computing devices or systems, such as other computing devices or systems included in the public safety communications system 100 depicted in FIG. 1. As such, the communication interface 806 may take any suitable form for carrying out these functions, examples of which may include an Ethernet interface, a serial bus interface (e.g., Firewire, USB 3.0, etc.), a chipset and antenna adapted to facilitate wireless communication, and/or any other interface that provides for wired and/or wireless communication. The communication interface 806 may also include multiple communication interfaces of different types. Other configurations are possible as well.

Although not shown, the computing device 800 may additionally include one or more other interfaces that provide connectivity with external user-interface components (sometimes referred to as “peripherals”), such as a keyboard, a mouse or trackpad, a display screen, a touch-sensitive interface, a stylus, a microphone, a headset, speakers, etc., which may allow for direct user interaction with the computing device 800.

It should be understood that the computing device 800 is one example of a computing device that may be used with the embodiments described herein. Numerous other arrangements are possible and contemplated herein. For instance, other computing devices may include additional components not pictured and/or more or fewer of the pictured components.

In the foregoing specification, various examples have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing,” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” “contains . . . a” does not, without more constraints, preclude the existence of additional identical elements in the process, method, article, or apparatus that comprises, has, includes, contains the element. Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

Also, it should be understood that the illustrated components, unless explicitly described to the contrary, may be combined or divided into separate software, firmware, and/or hardware. For example, instead of being located within and performed by a single electronic processor, logic and processing described herein may be distributed among multiple electronic processors. Similarly, one or more memory modules and communication channels or networks may be used even if examples described or illustrated herein have a single such device or element. Also, regardless of how they are combined or divided, hardware and software components may be located on the same computing device or may be distributed among multiple different devices. Accordingly, in this description and in the claims, if an apparatus, method, or system is claimed, for example, as including a controller, control unit, electronic processor, computing device, logic clement, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

It will be appreciated that some examples may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an example can be implemented as a computer-readable storage medium having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. For example, computer program code for carrying out operations of various examples may be written in an object oriented programming language such as Java, Smalltalk, C++, Python, or the like. However, the computer program code for carrying out operations of various examples may also be written in conventional procedural programming languages, such as the “C” programming language or similar programming languages. The program code may execute entirely on a computer, partly on the computer, as a stand-alone software package, partly on the computer and partly on a remote computer or server or entirely on the remote computer or server. In the latter scenario, the remote computer or server may be connected to the computer through a local area network (LAN) or a wide area network (WAN), or the connection may be made to an external computer (for example, through the Internet using an Internet Service Provider).

The terms “substantially,” “essentially,” “approximately,” “about” or any other version thereof, are defined as being close to as understood by one of ordinary skill in the art, and in one non-limiting example the term is defined to be within 10%, in another example within 5%, in another example within 1% and in another example within 0.5%. The term “one of,” without a more limiting modifier such as “only one of,” and when applied herein to two or more subsequently defined options such as “one of A and B” should be construed to mean an existence of any one of the options in the list alone (e.g., A alone or B alone) or any combination of two or more of the options in the list (e.g., A and B together).

A device or structure that is “configured” in a certain way is configured in at least that way, but may also be configured in ways that are not listed.

The terms “coupled,” “coupling” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through intermediate elements or devices via an electrical element, electrical signal or a mechanical element depending on the particular context.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A computer-aided dispatch (CAD) system for dispatching resources to a scene of an incident, the CAD system comprising:
at least one processor; and
at least one non-transitory computer-readable storage medium comprising program instructions that, when executed by the at least one processor, cause the CAD system to perform a set of operations comprising:
receiving, from a plurality of data sources, a collective dataset associated with the incident;
displaying an interface comprising a plurality of data input fields, each of the data input fields configured to receive respective data associated with the incident;
receiving, at a first data input field of the plurality of data input fields, a first user input comprising first data associated with the incident;
receiving, via the user interface, a second user input comprising a request to create a data variable for a second data input field of the plurality of data input fields;
based on the second user input, (i) creating the data variable for the second data input field such that the value of the data variable is used as the value for the second data input field and (ii) determining a data analytic for updating the value of the data variable;
applying the data analytic to the collective dataset associated with the incident to determine an updated value of the data variable; and
based on the first data and the updated value of the data variable, generating or updating a dispatch command for dispatching resources to the scene of the incident.

2. The CAD system of claim 1, wherein the collective dataset associated with the incident comprises one or more of (i) a video feed of the incident, (ii) an audio feed of the incident, (iii) communications from one or more responding officers assigned to the incident, (iv) communications from a caller or texter reporting the incident, (v) sensor data from one or more sensors deployed at the scene of the incident, (vi) social media data associated with the incident, or (v) news report data associated with the incident.

3. The CAD system of claim 1, wherein the second user input further comprises an indication of the data analytic for updating the value of the data variable, and wherein applying the data analytic comprises applying the data analytic indicated by the second user input.

4. The CAD system of claim 1, wherein determining the data analytic for updating the value of the data variable comprises determining the data analytic based on one or more of (i) a type of data that the second data input field is configured to receive, (ii) a type of the incident, or (iii) a CAD identifier for the incident.

5. The CAD system of claim 1, wherein the set of operations further comprises:
displaying the set of data associated with the incident, wherein the second user input comprises a selection of at least a portion of the displayed set of data.

6. The CAD system of claim 5, wherein the set of operations further comprises:
determining a context of the selected portion of the displayed set of data; and
based on the determined context, identifying the second data input field from among the plurality of data input fields as the data field corresponding to the request to create the data variable.

7. The CAD system of claim 6, wherein determining the data analytic for updating the value of the data variable comprises determining the data analytic based on the determined context of the selected portion of the displayed set of data.

8. The CAD system of claim 1, wherein receiving the second user input comprises receiving the second user input at the second data input field of the plurality of data input fields.

9. The CAD system of claim 1, wherein the set of operations further comprises:
determining a time duration for the data variable; and
automatically executing the generated or updated dispatch command after the determined time duration.

10. The CAD system of claim 1, wherein generating or updating the dispatch command for dispatching resources to the scene of the incident comprises using the updated value of the data variable in a mathematical expression, and wherein the set of operations further comprises:
displaying an indication of the mathematical expression;
receiving a third user input comprising a request to edit the mathematical expression; and
editing the mathematical expression based on the third user input, such that the generated or updated dispatch command is determined using the edited mathematical expression.

11. A method performed by a computer-aided dispatch (CAD) system for dispatching resources to a scene of an incident, the method comprising:
receiving, from a plurality of data sources, a collective dataset associated with the incident;
displaying an interface comprising a plurality of data input fields, each of the data input fields configured to receive respective data associated with the incident;
receiving, at a first data input field of the plurality of data input fields, a first user input comprising first data associated with the incident;
receiving, via the user interface, a second user input comprising a request to create a data variable for a second data input field of the plurality of data input fields;
based on the second user input, (i) creating the data variable for the second data input field such that the value of the data variable is used as the value for the second data input field and (ii) determining a data analytic for updating the value of the data variable;
applying the data analytic to the collective dataset associated with the incident to determine an updated value of the data variable; and
based on the first data and the updated value of the data variable, generating or updating a dispatch command for dispatching resources to the scene of the incident.

12. The method of claim 11, wherein the collective dataset associated with the incident comprises one or more of (i) a video feed of the incident, (ii) an audio feed of the incident, (iii) communications from one or more responding officers assigned to the incident, (iv) communications from a caller or texter reporting the incident, (v) sensor data from one or more sensors deployed at the scene of the incident, (vi) social media data associated with the incident, or (v) news report data associated with the incident.

13. The method of claim 11, wherein the second user input further comprises an indication of the data analytic for updating the value of the data variable, and wherein applying the data analytic comprises applying the data analytic indicated by the second user input.

14. The method of claim 11, wherein determining the data analytic for updating the value of the data variable comprises determining the data analytic based on one or more of (i) a type of data that the second data input field is configured to receive, (ii) a type of the incident, or (iii) a CAD identifier for the incident.

15. The method of claim 11, further comprising:
displaying the set of data associated with the incident, wherein the second user input comprises a selection of at least a portion of the displayed set of data.

16. The method of claim 15, further comprising:
determining a context of the selected portion of the displayed set of data; and
based on the determined context, identifying the second data input field from among the plurality of data input fields as the data field corresponding to the request to create the data variable.

17. The method of claim 16, wherein determining the data analytic for updating the value of the data variable comprises determining the data analytic based on the determined context of the selected portion of the displayed set of data.

18. The method of claim 11, wherein receiving the second user input comprises receiving the second user input at the second data input field of the plurality of data input fields.

19. The method of claim 11, further comprising:
determining a time duration for the data variable; and
automatically executing the generated or updated dispatch command after the determined time duration.

20. A non-transitory computer-readable storage medium comprising program instructions that, when executed by at least one processor, cause a computer-aided dispatch (CAD) system to perform a set of operations for dispatching resources to a scene of an incident, the set of operations comprising:
receiving, from a plurality of data sources, a collective dataset associated with the incident;
displaying an interface comprising a plurality of data input fields, each of the data input fields configured to receive respective data associated with the incident;
receiving, at a first data input field of the plurality of data input fields, a first user input comprising first data associated with the incident;
receiving, via the user interface, a second user input comprising a request to create a data variable for a second data input field of the plurality of data input fields;
based on the second user input, (i) creating the data variable for the second data input field such that the value of the data variable is used as the value for the second data input field and (ii) determining a data analytic for updating the value of the data variable;
applying the data analytic to the collective dataset associated with the incident to determine an updated value of the data variable; and
based on the first data and the updated value of the data variable, generating or updating a dispatch command for dispatching resources to the scene of the incident.
